(19) United States
(12) Patent Application Publication
(10) Pub. No.: US 2011/0202377 A1
(43) Pub. Date: Aug. 18, 2011

(54) METHOD AND SYSTEM FOR PROVIDING A SEGMENT BASED DIFFERENTIATED CUSTOMER EXPERIENCE SOLUTION

(75) Inventors: Rajashekara V. MAIYA, Bangalore (IN); Chandramouli KUNDAGRAMI, Bangalore (IN)

(73) Assignee: INFOSYS TECHNOLOGIES LIMITED, Bangalore (IN)

(21) Appl. No.: 12/760,632

(22) Filed: Apr. 15, 2010

(30) Foreign Application Priority Data
Feb. 17, 2010 (IN) 401/CHE/2010

(51) Int. Cl. G06Q 30/00; G06Q 10/00; G06Q 99/00; G06Q 50/00; G06Q 40/00; G06F 9/46; G06F 15/16; G06F 15/173

(52) U.S. Cl. 705/7.11; 705/14.51; 705/300; 719/313; 709/206; 709/223; 719/328

(57) ABSTRACT

A method for providing a segment based differentiated customer service solution. The method comprises a step of first receiving information about online status of a customer. The method includes providing one or more personalized offers based on the received information. Further, a remote financial advisor application for facilitating interaction between the customer and an advisor in an advisement session is invoked and financial analysis related to the purchase of one or more personalized offers is provided to the customer. The purchase of the personalized offer is then provisioned which comprises completing transaction details for the purchase. The method also includes facilitating the provision of real-time advice to the customer through a remote advisement session.

### FIELD OF INVENTION

The present invention relates generally to the field of customer services. More particularly, the present invention provides for segmented customer services by facilitating integration of multiple technologies and multiple channels.

### BACKGROUND OF THE INVENTION

As a result of use of novel technologies, customer service has undergone significant changes. Nowadays, customer service is provided using multiple software systems that are integrated with each other. Further, in order to provide enhanced customer services, organizations are motivated to offer innovative methods in the use of software systems for providing customer services.

Business objectives of a services organization, such as a bank, include growth, operational efficiency, customer satisfaction, customer loyalty, customer stickiness, profitability, leadership. These business objectives are largely driven by having an ‘engaged customer’ whose needs are easily met. In order to have a ‘satisfied customer’, various businesses are resorting to services innovation in order to gain a competitive edge in the marketplace. One of the examples of services innovation is the use of multiple channels for providing banking services. Such multiple channels include the use of Internet, Automated Teller Machines (ATMs), Telebanking, mobile devices including partners' eco-system. Further, enhanced customer satisfaction can be achieved by satisfying even non-banking needs of a customer, in addition to banking needs. This can be achieved by showing a pro-active understanding of the customer's needs, and pitching in to provide the right service for banking as well as non-banking needs at the right time, true to the customer's current context.

Examples of non-banking needs of a customer may include a variety of services related to travel, insurance, online shopping, advertising, education, real-time communication etc. Currently used technologies do not provide a unified experience to customers that satisfy their financial as well as non-financial needs. Nowadays, with the use of Web 2.0 technologies such as, social networking, blogging, instant messaging a comprehensive customer service experience can be provided to a customer by integrating multiple technologies and applications.

In the light of the above, there exists a need to integrate various technologies using a central framework to provide multiple services to customers. Further, there exists a need to have a solution for providing seamless services targeted to particular segment of customers for satisfying their particular needs.

### SUMMARY OF THE INVENTION

An object of the present invention is to provide a customer experience solution to customers that includes satisfying banking as well as non-banking needs of a customer by differentiating customers based on various factors such as customer demographics, interests, usage of specific services by customers etc. The system and method of the present invention is adapted to determine a current context of a customer and then based on the current context, the customer is presented with personalized offers. Further, the customer is provided with multiple software solutions which are integrated with each other in such a manner that multiple service offerings are provided to the customer in real-time.

In an embodiment of the present invention, the system includes one or more service applications comprising code configured to provide one or more services. Further, the system includes an integrator module configured to integrate the one or more service applications in order to provide the differentiated customer experience solution. The one or more service applications are integrated using enterprise application integration framework. For facilitating communication between the one or more service applications and the integrator module, a host integration framework is provided that comprises functionalities for issuing service requests and managing responses. The one or more service applications comprises at least one of internet banking, mobile banking, remote advisement, customer experience solutions, financial applications and applications provided by partner portals.

In related embodiments of the present invention, the integrator module comprises one or more Java APIs configured to enable implementation of the one or more service applications, a rule set layer configured to parse a request XML message and convert the message into a Java message object, a websphere SOAP servlet configured to generate responses based on requests received from a web services enabled client, an interface layer configured to transform the Java message object into an underlying host format and provide the formatted message to an adaptor layer and an adaptor layer configured to adapt and route the Java message object to a back-end host system. The back-end host system includes one or more software components configured to manage back-end processing for the implementation of one or more services applications. The integrator is further configured to integrate the back-end host system with the one or more service applications using adaptors and translators. In exemplary embodiments, the interface layer is further configured to provide the Java message object to a database for future retrieval.

In related embodiments of the present invention, the back-end host system comprises an SSO system configured to facilitate single user sign-on for accessing multiple service applications, a CRM system configured to manage customer relationships using software tools for interacting with customers, a Core system configured to manage banking transactions related to the one or more service applications and an Alert Server configured to facilitate delivery of alerts linked with provision of the one or more service applications.

In various embodiments of the present invention, the exchange of messages between an asynchronous client and the integrator is executed using message oriented middleware for exchanging the messages. In other embodiments, exchange of messages between a Java client and the integrator is executed using remote method invocation.

In various embodiments of the present invention, the host integration framework includes an orchestrator configured to receive an incoming request and co-ordinate processing of the request, a request processor comprising modules for splitting the request and executing sequencing, pagination and composition of a response message, a message adaptor module configured to manage processing of individual messages and a protocol handler module configured to provide protocol-specific logic pertaining to at least one of TCP/IP protocol, JMS protocol and JDBC protocol. In related embodiments, the orchestrator comprises a transaction management module configured to enable composition and co-ordination of services into transactions and collaborative business processes and a state management module configured to ascertain current activity in progress for the request.

In various embodiments of the present invention, the system of the present invention further comprises a lifecycle management module configured to manage processing of entire lifecycle of a transaction associated with a customer service application, a message transformer configured to manage transformation of messages from a particular format to a system understandable format, a tooling module configured to facilitate protocol mapping and transforming from an underlying technology perspective, an infrastructure management module configured to map one or more infrastructure components downstream and upstream, a persistence module configured to continuously monitor and bring quality control equivalent functionality between interaction of various modules and an administration and monitoring module adapted to configure and manage administrative activity related parameters for the entire lifecycle of a transaction.

In various embodiments of the present invention, the method for providing segment based differentiated customer experience solution comprises receiving information about online status of a customer, providing one or more personalized offers based on the received information, invoking remote financial advisor for facilitating interaction between the customer and an advisor in an advisement session, providing financial analysis related to the purchase of one or more personalized offers and provisioning the purchase of a personalized offer comprising completing transaction details for the purchase. The method further comprises facilitating the provision of real-time advice to the customer through a remote advisement session.

In related embodiments of the present invention, the purchased personalized offer may be a trip to a distant location. In this embodiment, the method comprises tracking physical location of the customer on the trip using a mobile GPS system, generating personalized offers based on location of the customer, customer preference and current activity context and communicating the offers to the customer in the form of alerts.

### BRIEF DESCRIPTION OF THE ACCOMPANYING DRAWINGS

The present invention is described by way of embodiments illustrated in the accompanying drawings wherein:

FIG. 1 is a schematic diagram illustrating high level interaction between software modules in a service oriented architecture for providing segment based differentiated customer experience;

FIG. 2 depicts an architectural diagram illustrating integration capabilities of an integrator, in accordance with an embodiment of the present invention;

FIG. 3 is a schematic diagram illustrating business process flow through integrator framework, in accordance with an embodiment of the present invention;

FIG. 4 illustrates architectural diagram of an integrator in communication with clients and services module, in accordance with an embodiment of the present invention.

FIG. 5 illustrates logical architecture of a host integration framework, in accordance with an embodiment of the present invention;

FIGS. 6 and 7 illustrates a flowchart depicting method steps involved in providing segment based differentiated customer services, in accordance with an embodiment of the present invention;

FIG. 8 illustrates a flowchart depicting method steps involved in providing segment based differentiated customer services, in accordance with another embodiment of the present invention;

FIGS. 9, 10, 11 and 12 illustrates screenshots depicting provision of multiple customer services based on factors related to customer's online status and behavior.

### DETAILED DESCRIPTION OF THE INVENTION

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purpose of clarity, details relating to technical material that is known in the technical fields related to the invention have been briefly described or omitted so as not to unnecessarily obscure the present invention.

The present invention would now be discussed in context of embodiments as illustrated in the accompanying drawings.

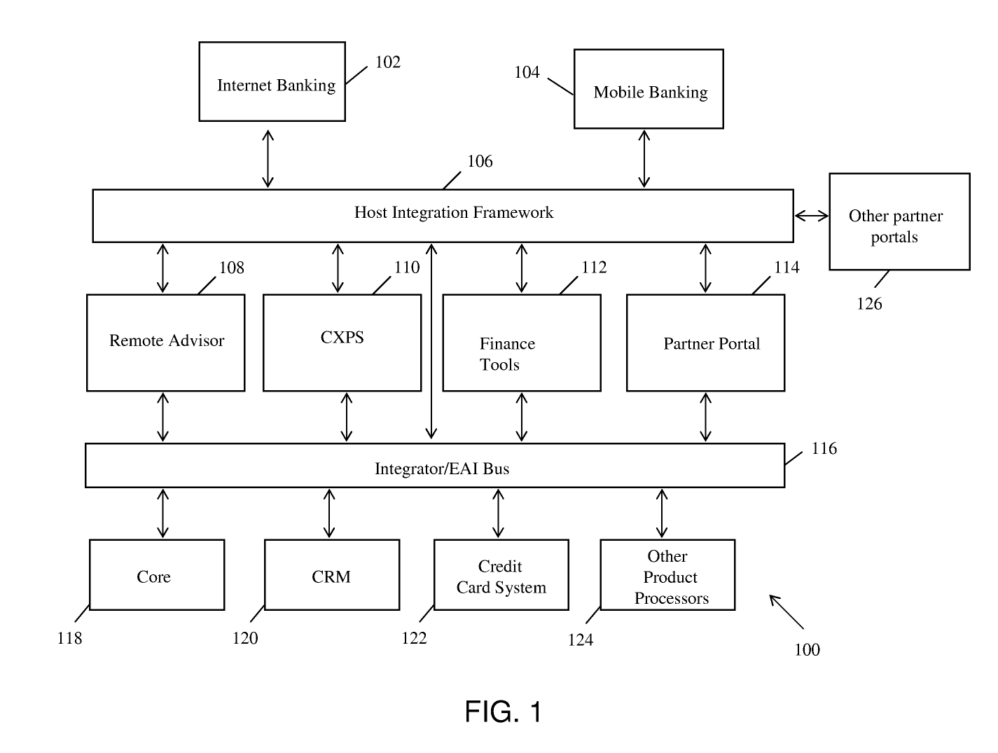

FIG. 1 is a schematic diagram illustrating high level interaction between software modules in a service oriented architecture for providing segment based differentiated customer services. In various embodiments of the present invention, the customer services may be services related to banking products, financial planning, travel related services, insurance services etc. Further, the service can be provided directly by the bank, or by a partner eco-system of the bank, based on understanding of the customer's contextual need. In various embodiments of the present invention, the customer services are interconnected using various software tools.

As shown in the figure, the architecture comprises software modules: Internet Banking 102, Mobile Banking 104, Remote Advisor 108, Customer Experience Solution (CXPS) module 110, Finance Tools 112 and Partner Portal 114. The above mentioned software modules provide various distinct customer services such as, providing banking transactions through Internet and mobile devices, remote advisory by a customer service agent, providing financial product analysis and comparisons, providing miscellaneous and additional banking and non banking services through partner portals, providing personalized services using a real-time management engine, etc. In order to provide the customer services, the modules interact with each other using an Integrator/Enterprise Application Integration (EAI) Bus 116. In an embodiment of the present invention, the Integrator 116 is a Java 2 Enterprise Edition (J2EE) application comprising stateless Enterprise Java Bean (EJB), Message Driven Bean (MDB) and Java Bean classes. The Integrator 116 is configured to integrate customer service applications provided by the software modules so that the applications talk to each other in order to provide a differentiated customer experience solution to a customer. The Integrator 116 is further configured to provide Application Programming Interfaces (APIs) to process requests posted from external systems that provide products to a customer such as: a Customer Relationship Management (CRM) system 120, a Credit Card System 122 and Other Product Processors 124. Moreover, the Integrator 116 is configured to provide APIs to handle requests posted from internal modules such as, Remote Advisor 108, CXPS 110 etc. The architecture further comprises a Core module 118 which has a layered Service Oriented Architecture (SOA) with functionality rich modules and a comprehensive repository for storing data used by modules to provide solutions. The Host Integration Framework (HIF) 106 is a module that provides fundamental functionalities for servicing requests and issuing responses for communication between the software modules.

In an embodiment of the present invention, the Internet Banking module 102 is a module providing banking transactions to customers using the Internet. Similarly, the Mobile Banking module 104 is configured to facilitate banking transactions using mobile phones and various other electronic communication devices connected via a telecommunication network. The Remote Advisor 108, the CXPS 110, the Finance Tools module 112 and the Partner Portal 114 are other modules that are configured to provide enhanced customer services. In an embodiment of the present invention, the remote advisor 108 is a software application configured to determine context of use of a web application by a user. Additionally, the application is further configured to select a suitable advisor for the user based on the context of use and to provide the user with access to an advisor using audio/video technologies and instant messaging.

The CXPS module 110 comprises a real-time intelligent, conversation and interaction management engine that is configured to add conversational intelligence to customer interactions, in real time. In an embodiment of the present invention, the CXPS module 110 assimilates real-time and offline data, structured or unstructured through multiple channels or interactions such as transaction events, business activity and emotions in order to personalize customer interactions. Finance Tools module 112 comprises a set of tools for financially comparing and analyzing various products offered by a organization in order to determine their suitability with respect to costs and available features. In various embodiments of the present invention, finance tools facilitate financial calculation and simulation, act as sales and marketing tools for the financial services sector and facilitate novel product selection, comparison, ranking and filtering.

The partner portal 114 is a portal in partnership with a primary website of a service provider, wherein the customer can access miscellaneous products and services. For example, a customer of a bank may access a partner portal of a cheque book issuing servicing company that issues and delivers cheque books to customers.

For providing various value added services to customers, the modules: Internet Banking 102, Mobile Banking 104, Remote Advisor 108, Customer Experience Solution (CXPS) module 110, Finance Tools 112 and Partner Portal 114 interact with the core module 118 which is a framework that connects all software modules for providing a customer solution. In an embodiment of the present invention, interaction with the core 118 is through the integrator 116. The CRM system 120 is system that includes software and methods for interacting effectively with customers in order to obtain a current context of the customer. Obtaining current context of the customer helps in understanding the needs of the customer in order to provide better services. The core 118 is also responsible for integrating the Credit Card System 122 and other product processors 124 with other software modules.

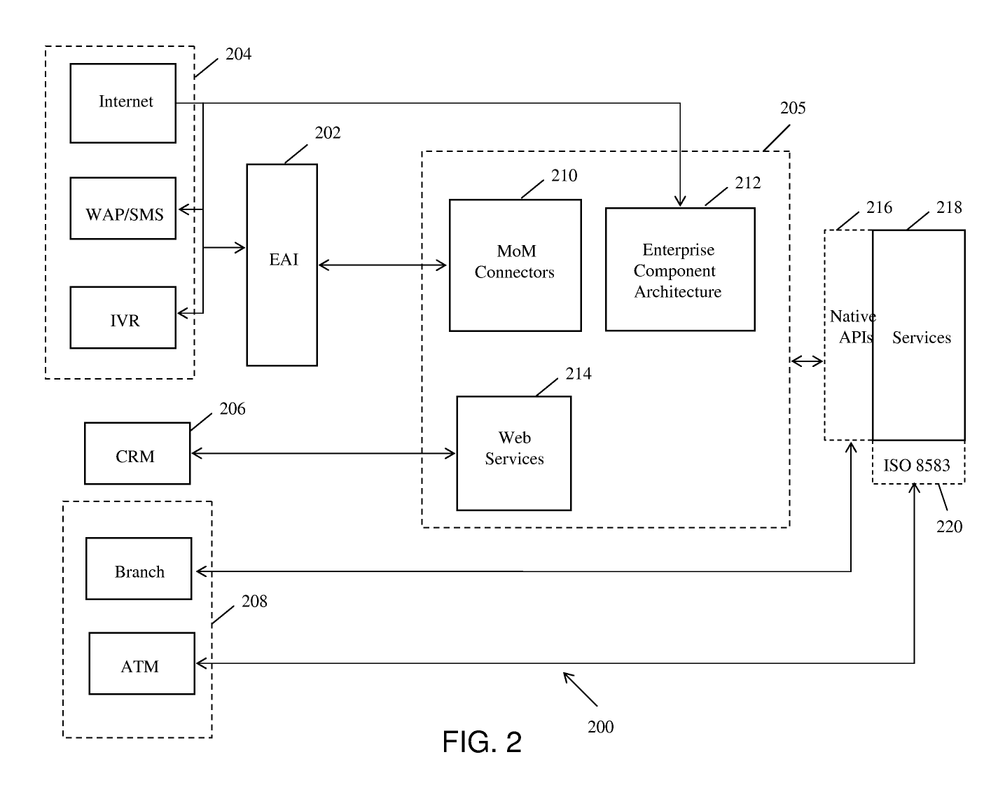

In an embodiment of the present invention, the Integrator/EAI Bus 116 is a form of middleware for integrating distributed applications, whereas the Host Integration Framework (HIF) 106 is a backbone that handles all aspects of processing of requests for access to any of the software modules. The Integrator 116 and the HIF 106 are described in detail in conjunction with the description of FIGS. 2, 3, 4 and 5.

FIG. 2 depicts an architectural diagram 200 illustrating integration capabilities of an integrator. The architectural diagram 200 comprises the integrator which facilitates to integrate one or more software systems and protocols with various services offered to customers. The services may comprise one or more of internet services, mobile banking services or other specialized services such as remote advisor, partner portal, finance tools etc. In an embodiment of the present invention, the services may need access to existing software system infrastructure and protocols for providing various services to customers. As shown in the figure, software system infrastructure 204 comprises systems and protocols such as the Internet, Wireless

Application Protocol (WAP), Short Message Service (SMS), Interactive Voice Response (IVR) etc.

In various embodiments of the present invention, the architectural diagram 200 comprises a framework 205 including Message Oriented Middleware (MOM) connectors 210, Enterprise Component Architecture 212 and Web Services 214. MOM connectors are programs that synchronize MOM data between one or more services offered by the services module 218 and the software system infrastructure 204. In an exemplary embodiment of the present invention, services offered by the services module 218 include functional services such as products, infrastructure services such as interest, fees, calendar or currency, and transactional services such as cash deposit, cash withdrawal, payments, remittances etc. The Enterprise Component Architecture 212 comprises specifications for providing processing of enterprise applications. In various embodiments of the present invention, processing of enterprise applications may include transaction processing, messaging services, inter-process communication, security issues, software component deployment etc. In an exemplary embodiment of the present invention, Enterprise Component Architecture provides capabilities to interact with other enterprise systems that an organization has such as a Human Resource (HR) system, payroll system, procurement system, purchase and invoicing system etc. An example of Enterprise Component Architecture 212 may include Enterprise Java Beans.

In various embodiments of the present invention, the CRM system 206 may need to interact with the web services module 214 for providing CRM services to customers. The CRM system 206 provides the contextual information of the customer, his/her 360 degree view from a unified relationship perspective, his/her service requests/complaints, his/her opportunities, sales funnel etc. As shown in the figure, the CRM services have been exposed as web services so that the same can be consumed by channels as well as by any third party applications through the services module 218.

As shown in the figure, the personal banking module 208 that comprises Branch offices and ATM machines interact with the services module 218 using Native

Application Programming Interfaces (APIs) 216 and protocols such as, ISO 8583 220. The protocol ISO 8583 is a protocol that defines message format and communication flow for card initiated transactions.

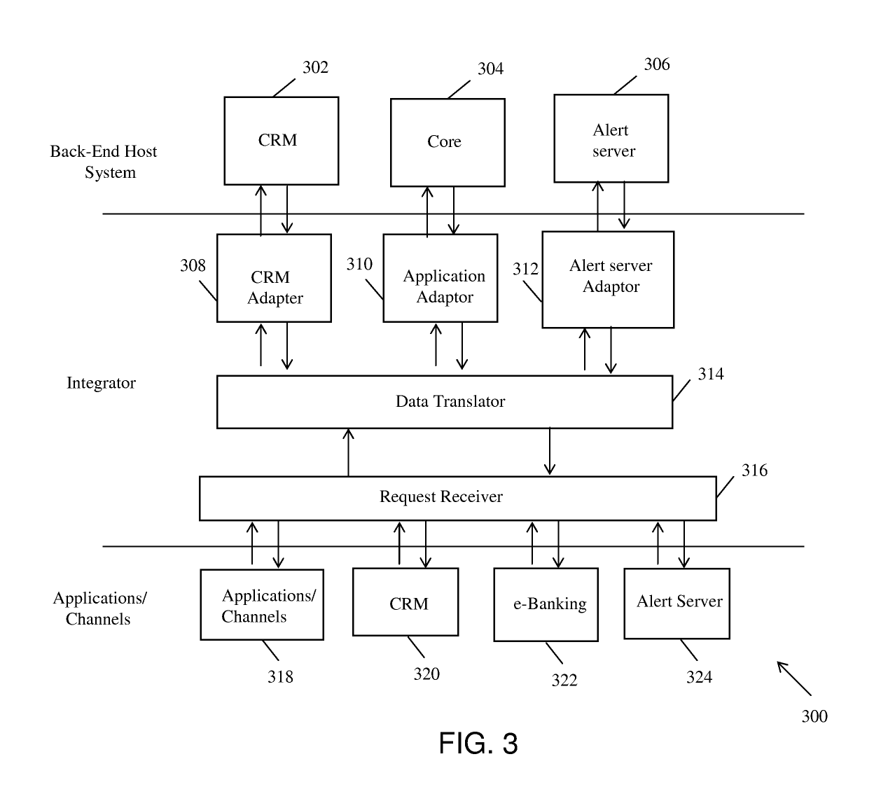

FIG. 3 is a schematic diagram illustrating business process flow through integrator framework. As shown in the figure, the schematic diagram comprises a back-end host system, an Integrator and Applications/Channels. The Back-End host system comprises a Back-end CRM system 302, a Core 304 and an Alert Server 306. The CRM system 302, the core 304 and the Alert Server 306 are connected to customer master files, databases, Enterprise Resource Planning (ERP) systems, processing systems etc. The Integrator is configured to integrate the Back-end host system with Applications/Channels using adaptors and data translators.

In various embodiments of the present invention, the request receiver 316 is configured to receive access request by the modules: Applications/Channels 318, CRM system 320, E-Banking system 322 and Alert server 324. In an exemplary embodiment of the present invention, the request receiver 316 may include Component architectures, web services, Message Oriented Middleware APIs, etc. After receiving the request, the integrator performs data translation using the data translator 314. Activities related to data translation comprise activities such as, reference coding, defaulting and back-end specific translation.

As shown in the figure, the integrator comprises a CRM adapter 308, an application adapter 310 and an alert server adapter 312. In various embodiments of the present invention, the CRM adapter 308, the application adapter 310 and the alert server adapter 312 are configured to adapt the translated data so that data related to the request is utilized by the back-end systems: the CRM system 302, the core 304 and the alert server 306.

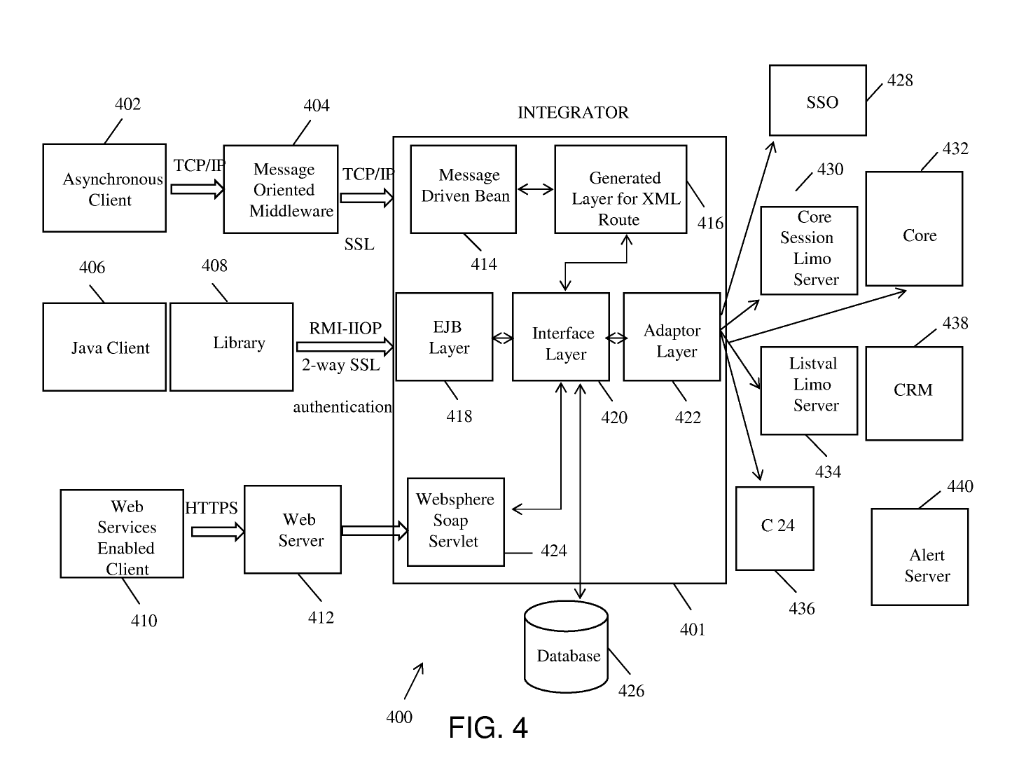

FIG. 4 illustrates architectural diagram of an integrator in communication with clients and services module, in accordance with an embodiment of the present invention. As shown in the figure, the integrator 401 comprises a Message Driven Bean (MDB) 414, a Generated Layer for XML route 416, an EJB layer 418, an interface layer 420, an adapter layer 422 and a Websphere SOAP servlet 424 for facilitating communication between clients and service modules of the system of the invention.

The interaction between clients and services as illustrated is initiated by client applications such as an asynchronous client 402, a Java client 406 and a Web Services Enabled Client 410. The client applications may be software applications implementing customer services such as internet banking, mobile banking, remote advisement, partner portals implementing other services, etc.

In an embodiment of the present invention, the asynchronous client 402 initiates one or more message exchanges with the integrator 401. The asynchronous client 402 uses TCP/IP application protocol for communicating with Message Oriented Middleware (MOM) 404 which in turn interacts with the MDB 414. MOM 404 is middleware that provides industry standard based interaction for request and response mechanisms. In an exemplary embodiment of the present invention, the MOM 404 typically follows widely accepted open standards for exchanging information from and to different systems that interact with them. As shown in the figure, the MOM 404 is configured to relay one or more messages initiated by the asynchronous client 402 to the MDB 414. The MOM 404 does not require that the message sent by the asynchronous client 402 be structured in a particular format. Further, the asynchronous client 402 and the integrator 401 may not synchronize to communicate or may be loosely coupled. MOM 404 uses Secure Socket Layer (SSL) technology with digital certificate based authentication for sending messages to the integrator. In an embodiment of the present invention, the MOM 404 uses Simple

Object Access Protocol (SOAP) for exchanging structured information between the asynchronous client 402 and the MDB 414.

In various embodiments of the present invention, the MDB 414 is an Enterprise Bean that facilitates processing of asynchronous messages. A message-driven bean is an enterprise bean that allows J2EE applications to process messages asynchronously. In an exemplary embodiment of the present invention, the MDB 414 is hosted by an EJB container. MDB 414 acts as a Java Message Service (JMS) message listener i.e, it listens on a JMS Queue for request messages. When the MOM 404 puts the message in the JMS Queue, the message is consumed by the MDB 414. The request is processed and response sent to a configured response Queue. In an embodiment of the present invention, the response may then be delivered to a back-end host system through the interface layer 420 and the adapter layer 422 for processing the message. In another embodiment of the present invention, the response may be stored in a database 426 for future retrieval.

The back-end host system is a system that manages back-end processing of processes related to the implementation of a service. As illustrated in the figure, the back-end host system comprises a Single Sign-On (SSO) system 428, a Core 432, a CRM system 438 and an Alert Server 440. For delivering a response message to the back-end host system or to the database 426, the message is routed through the Generated Layer for XML route 416, the interface layer 420 and the adapter layer 422. The Generated Layer for XML route (Rule Set Layer) 416 is a generated layer for Out of the Box (OOTB) product APIs. The Layer 416 is configured to parse a request message in XML format and provide the message to the interface layer 420. The Layer 416 is also configured to convert the request message in XML format into a Java Value Object (VO). The Java VO is a Java message object that encapsulates data existing in the request message and is passed to any other application requesting access to the message. Using the Java VO, number of remote calls for data transfer between the asynchronous client and the back-end host system gets reduced.

The Java message object gets transformed into the underlying host format in the interface layer 420. In various embodiments of the present invention, custom hooks are available in this layer for providing the message object to the back-end host system. Eventually, the message object communicates with components of the back-end host system through the adapter layer 422.

The back-end host system comprises the components SSO system 428, the CRM system 438 and the Alert Server 440. The SSO system is an access control system that facilitates a single user sign-on for accessing multiple applications. In an embodiment of the present invention, the SSO system 428 enables a single sign-on access for accessing multiple services by the user. Similarly, the Core 432, the CRM system 438 and the Alert Server 440 are configured to implement processes related to the provision of services such as internet banking, mobile banking, remote advisement and the like.

As shown in the figure, the Java client 406 communicates with the integrator using Remote Method Invocation (RMI) over Internet Inter-Orb Protocol (HOP). RMI over IIOP facilitates creation of applications in which methods of remote Java objects can be invoked from other Java virtual machines. Further, the RMI/IIOP protocol implements a 2-way Secure Socket Layer (SSL) authentication. In an exemplary embodiment of the present invention, the Java client 406 utilizes a library 408 for interacting with components of the integrator 401. The library 408 is a repository of java scripts, java classes and presentation layer logic for the interaction to be more effective and contextual. The Java client 406 does a remote lookup on services offered by the integrator 401 by invoking access layer resources. The EJB layer 418 contains enterprise java beans corresponding to business services that are exposed through the integrator 401.

In various embodiments of the present invention, the web server 412 is configured to serve web requests from a web services enabled client 410. As shown in the figure, the integrator 401 comprises the Websphere SOAP Servlet 424 that generates responses based on requests received from the web server 412. SOAP/HTTP requests are handled by a single web service end point which is Web Services Interoperability (WS-I) document style based. A WS-I document may include a document implementing protocols such as, SOAP, Web Service Definition Language (WSDL) and Universal Description Discovery and Integration (UDDI) for handling requests irrespective of the initiating location or platform.

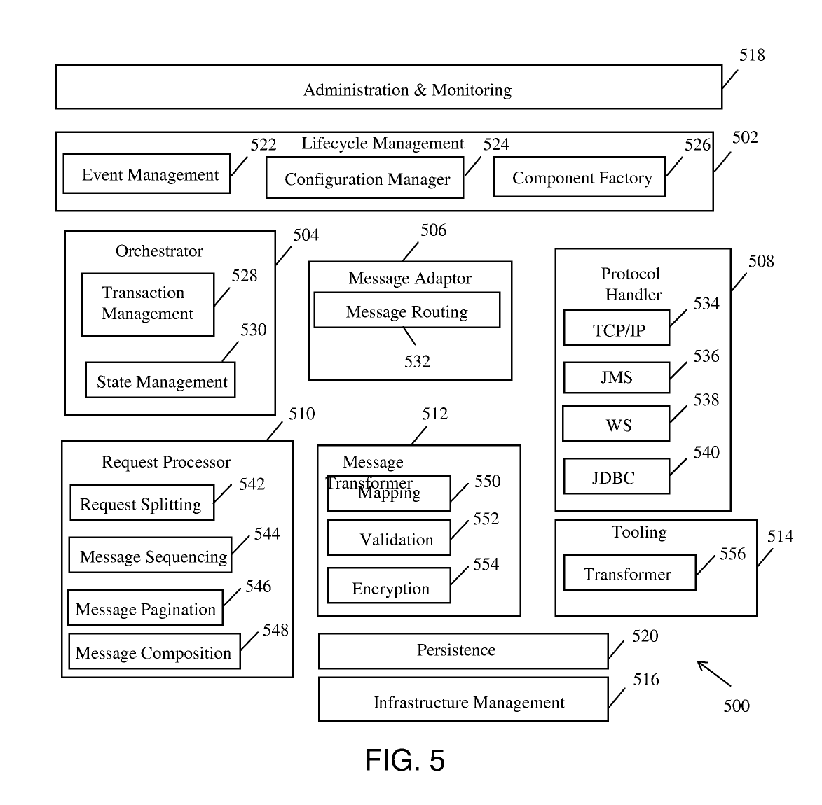

FIG. 5 illustrates logical architecture of a host integration framework 500, in accordance with an embodiment of the present invention.

As shown in the figure, the host integration framework 500 comprises a Lifecycle Management module 502, an Orchestrator 504, a Message Adaptor 506, a Protocol Handler 508, a Request Processor 510, a Message Transformer 512, a Tooling module 514, an Infrastructure Management module 516, an Administration & Monitoring module 518 and a Persistence module 520.

In various embodiments of the present invention, the Lifecycle Management Module 502 is configured to manage processing of entire lifecycle of a transaction associated with a customer service application managed by the Integrator 116 (FIG. 1). For example, the customer service application may be a request for provision of online business resources for entrepreneurial ideas. The execution of such an application may require the Integrator 116 (FIG. 1) to process various transactions, which is facilitated by software modules of the Host Integration Framework 500. The Lifecycle Management Module 502 comprises an event management module 522, a configuration manager 524 and component factory 526. The event management module 522 is configured to handle several business events and triggers that require monitoring. This includes managing business events as and when they occur. In an exemplary embodiment, if there is debit transaction happening to an account, which can be configured as an event to be tracked and communicated back to the customer as an alert, in such situations, the event management module 522 monitors the transaction event. The Configuration Manager 524 helps in configuring and parameterizing application related values corresponding to events and in managing and maintaining the configured values. Further, the configuration manager 524 controls the behavior of subsequent tasks in accordance with values set in the Configuration Manager 524 for those set of events. The Component Factory 526 manages various components that are required to orchestrate an activity under life cycle management of the whole interaction associated with a transaction. These components can be software components, server components or application components.

The orchestrator 504 receives incoming request and orchestrates processing of the request. In an embodiment of the present invention, the orchestrator 504 comprises transaction management module 528 and state management module 530. The orchestrator 504 enables composition and co-ordination of services into transactions and collaborative business processes using the transaction management module 528. The transaction management module 528 co-ordinates with the state management module 530 for ascertaining a current activity in progress for a particular process, such as, a request. Execution of a request may comprise exchanging one or more messages between modules in the host integration framework 50.

The request processor 510 comprises request splitting 542, message sequencing 544, message pagination 546 and message composition 548. In various embodiments of the present invention, the above mentioned modules are configured to break down a request and processes activities such as pagination and splitting. Further, the message composition module 548 is configured to compose response for individual messages.

The message adaptor module 506 is configured to manage processing of individual messages. Further, the message adaptor module 506 comprises a message routing module 532 that is configured to route messages.

The protocol handler module 508 is configured to provide protocol-specific logic to one or more APIs in the Integrator 116. The protocol-specific logic facilitates communication between clients and modules of back-end host system pertaining to the following protocols: Transmission Control Protocol/Internet Protocol (TCP/IP), Java Message Service (JMS) and Java Database Connectivity (JDBC). Further, the tooling module 514, is used for helping protocol mapping and transforming from an underlying technology perspective such as providing tools for handling JMS, TCP/IP, WS or JDBC connections.

The module Message Transformer 512 manages transformation of messages from a particular format to a system understandable format. For example, in case of a message being required to be transformed from a custom format to a standard format such as ISO 8583, the Message Transformer 512 comprises the modules Mapping 550, Validation 552 and Encryption 554 for handling the transformation. Mapping 550 caters to mapping of fields and values to handle transformation from one format to another. During transformation, if validation needs to be performed for any wrong mapping or transformation, Validation component 552 is configured to handle such requirements. Further, Encryption module 554 takes care of need for encrypting any sensitive field or data in a message, once the message is transformed to system understandable format.

The Infrastructure Management module 516 takes care of mapping of various infrastructure components downstream as well as upstream and the Persistence module 520 is configured to continuously monitor and bring quality control equivalent functionality between the interaction and also checks for online/offline status of customer on a persistent basis.

Finally, the Administration and Monitoring module 518 is adapted to configure and manage administrative activity related parameters for the entire lifecycle of a transaction, such as creation of users, technical and business parameter administration and monitoring.

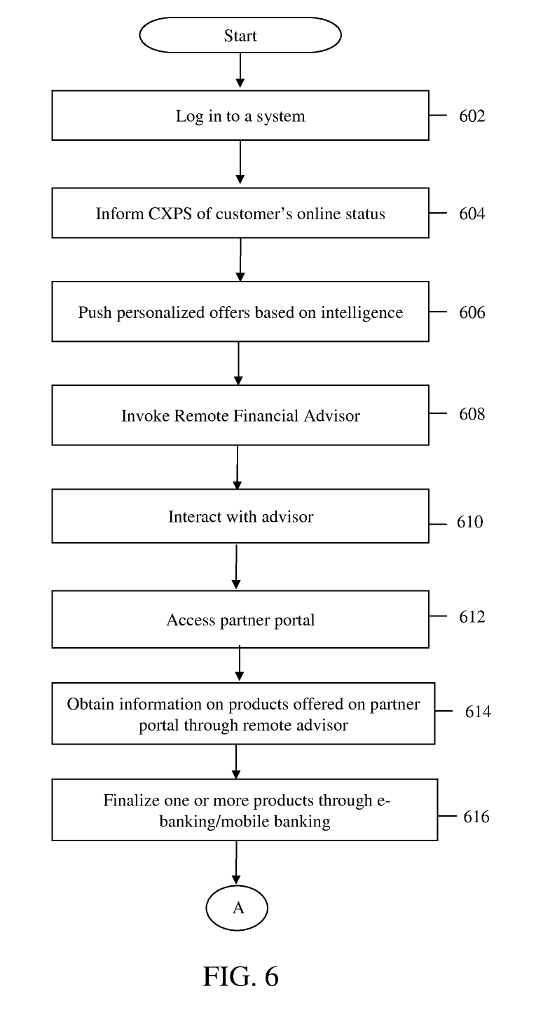

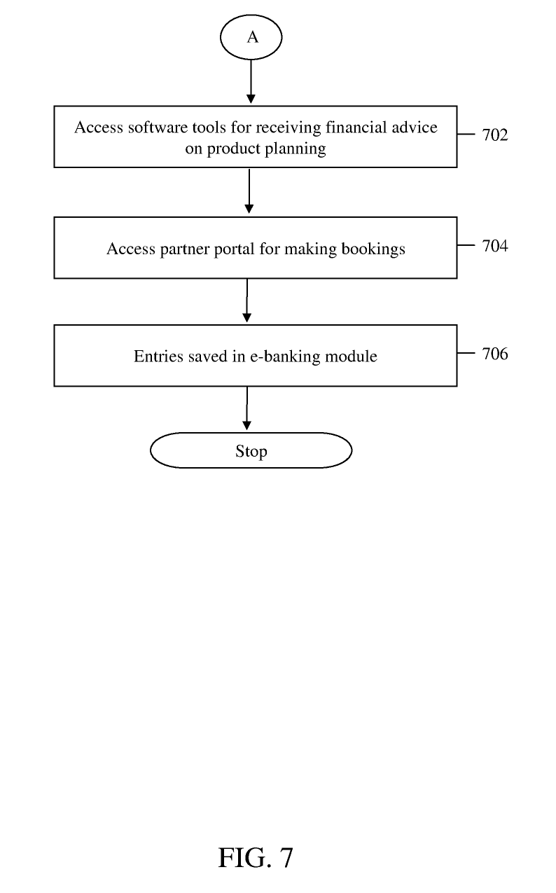

FIG. 6 illustrates a flowchart depicting method steps involved in providing segment based differentiated customer services in planning stage of buying a product, in accordance with an embodiment of the present invention. In various embodiments of the present invention, providing differentiated customer services based on a targeted segment entails use of multiple software tools by a customer wherein the software tools are integrated with each other using a software framework.

As shown in the figure, the method steps include logging into system of the present invention by the customer at step 602. At step 604, the system of the present invention informs a Customer Experience Solution (CXPS) system of a customer's online status. In an exemplary embodiment of the present invention, type of information provided to the CXPS system includes transaction information, transformation information and tacit information. The information may contain customer transaction behavior, his/her inputs, feedback, hobbies, likes, dislikes and other unstructured information that cannot be parameterized otherwise. In an embodiment of the present invention, CXPS is a real-time intelligent, conversation and interaction management software engine that is configured to add conversational intelligence to customer interactions in real-time. Further, the CXPS system is configured to factor new information in real-time and intelligently participate in customer interactions simulating real time human conversation. At step 606, the CXPS engine pushes in personalized offers based on intelligence onto a dashboard. Based on online searches conducted by customer, the customer may be presented with personalized offers. In an exemplary embodiment of the present invention, if the customer conducts online searches for business offers on websites such as, ‘Coolbusiness ideas.com’, ‘Entrepeneur.com’, ‘Fortune.com’ etc., the customer may be provided with links related to business offers on the dashboard. In another exemplary embodiment of the present invention, if the customer conducts one or more online searches on adventure websites, the CXPS engine provides links to Uniform Resource Locator's (URL's) related to adventure tours, partner websites advertising adventure sports etc on the dashboard. Additionally, the CXPS engine may display latest news related to one or more adventure destinations.

At step 608, the system invokes a remote financial advisor which can be used by a customer for seeking advice with respect to buying of a product. Thereafter, at step 610, the customer interacts with an advisor. In an embodiment of the present invention, the system of the invention comprises multiple advisors accessing advisor applications on their respective terminals. Further, the system routes a request for an advisement session sent by a customer to multiple advisor applications. In an exemplary embodiment, an appropriate advisor application responds to the request and sets up advisement session with the customer, thereby providing information about various products.

Based on information received from a remote advisor, the customer accesses a partner portal at step 612 to obtain more information about product details. In various embodiments of the present invention, a customer browses through featured offerings of a product and gains better insights through blogs, videos, ratings etc.

In an embodiment of the present invention, at step 614, the customer may again access a remote advisor to obtain information about products offered on the partner portal. Thereafter, at step 616, the customer finalizes one or more products offered on the partner portal. The customer finalizes the products using e-banking or mobile banking.

Once a product has been finalized, at step 702, the customer accesses one or more software tools for receiving financial advice on product planning. A customer may set up saving goals using the software tools to meet costs of a suggested offer. At step 704, the customer may again access partner portal for booking a product. In an embodiment of the present invention, the customer may be directed to the CXPS module for suggesting additional products related to the selected product.

Finally, at step 706, appropriate entries are made in e-banking module/mobile banking module corresponding to the selected product. For example, if the customer purchases an adventure trip as a product, the trip details, such as travel dates are saved in the calendar.

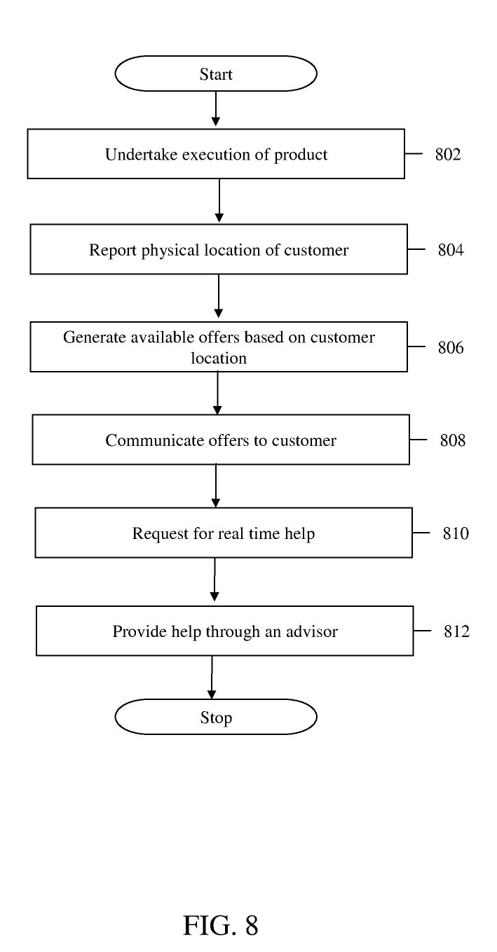

FIG. 8 illustrates a flowchart depicting method steps involved in providing segment based differentiated customer services. In an exemplary embodiment of the present invention, the customer purchases an adventure trip using the system modules of the invention. As shown in the figure, at step 802, the customer undertakes execution of the product, i.e. embarks on the trip. At step 804, the system of the invention tracks physical location of the customer. In an embodiment of the present invention, the physical location may be tracked through a Mashup solution linked with mobile Global Positioning System (GPS). The customer location may be passed by mobile banking to CXPS module. At step 806, the CXPS module may generate best offers available within range of customer's physical location based on customer preference and current activity context.

At step 808, the offers are communicated to the customer as alerts. In an example, the alerts may be alerts sent through mobile banking (SMS) or email alerts (e-banking). Thereafter, at step 810, if the customer is in need of help, he may send an SOS through his mobile device. In an example, the customer may be lost during travelling and may need help with respect to directions to a particular location. A mobile banking module relays the request to an advisor through remote advisor module. Thereafter, at step 812, an advisor may provide real-time help to the customer.

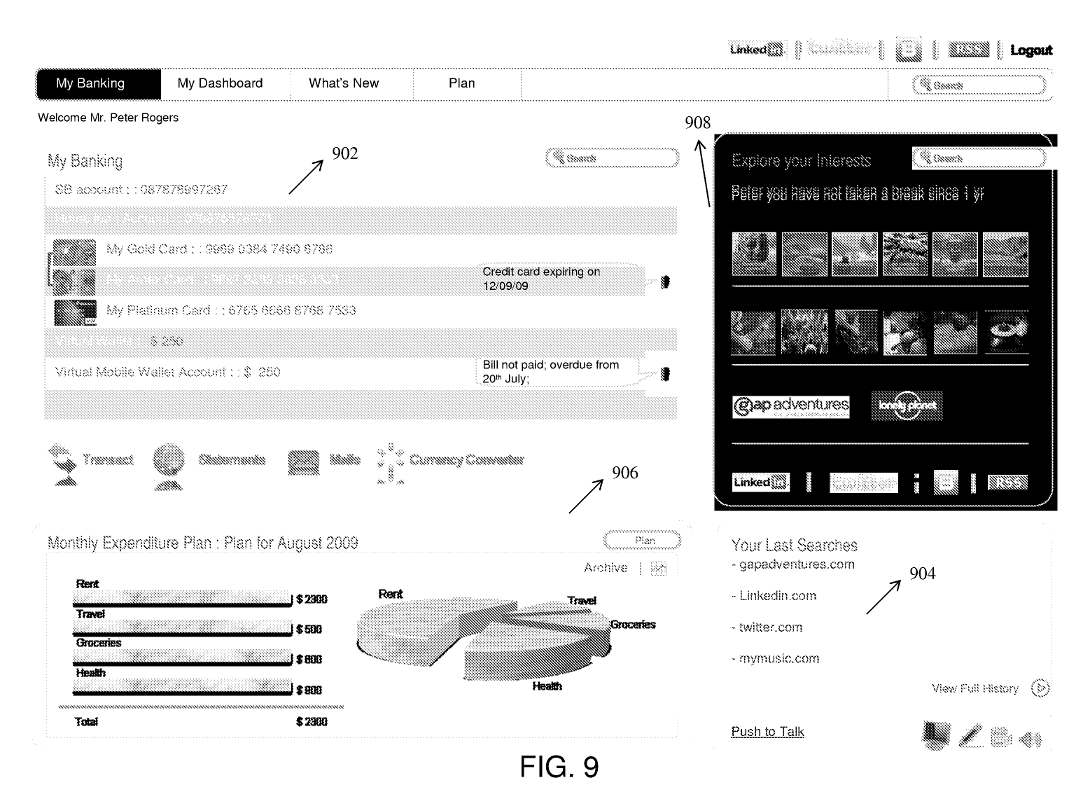

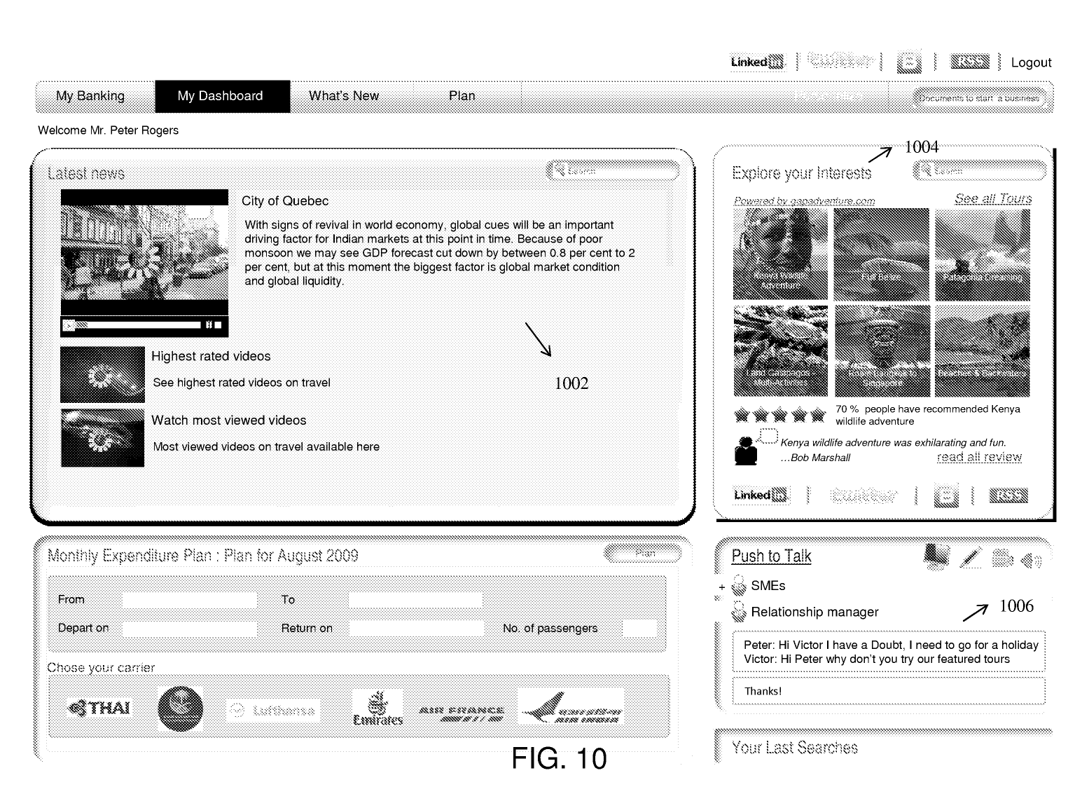

FIGS. 9, 10, 11 and 12 illustrates screenshots depicting provision of multiple customer services based on factors related to customer's online status and behavior. FIG. 9 illustrates screenshot of e-banking page of a customer. As shown in the figure, based on Banking Information 902, online searches 904 and monthly expenditure plan 906, personalized offers 908 related to adventure trips are displayed. Further, on the customer dashboard, news related to a particular location 1002 is displayed along with clickable icons 1004 for each location along with reviews for each location. Also, the system activates a remote advisement session 1006 to enable the customer to interact with a remote advisor for obtaining travel advice.

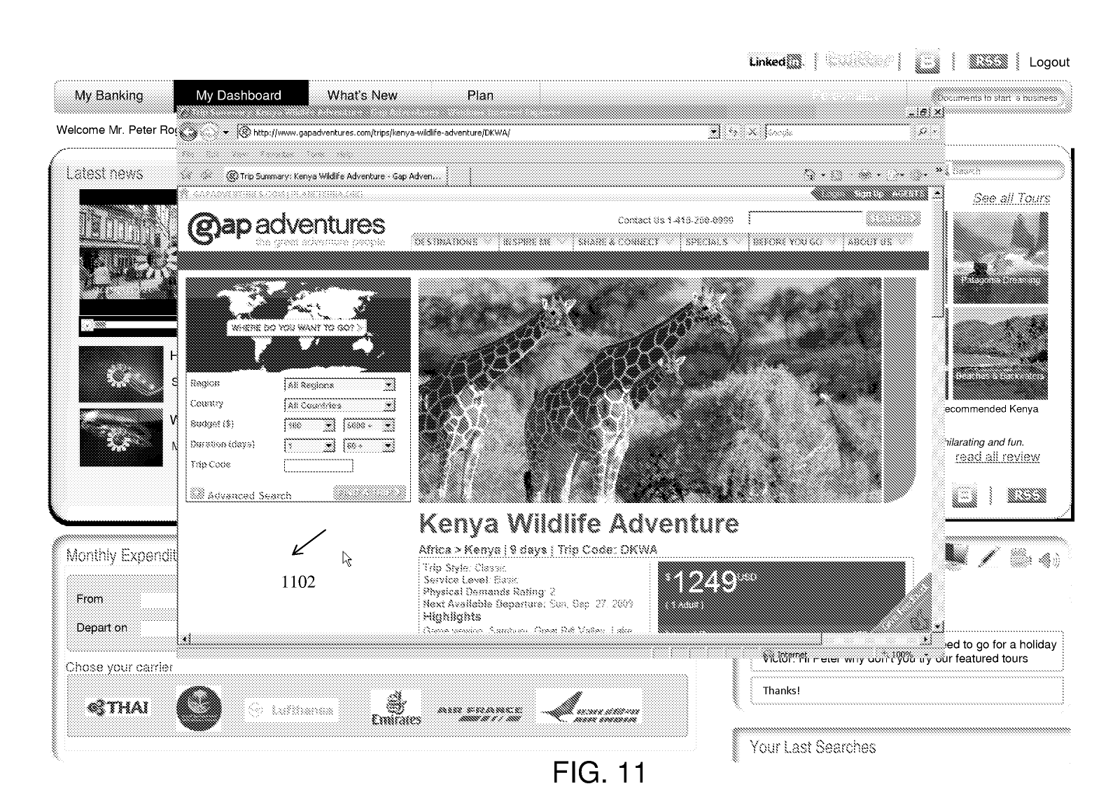

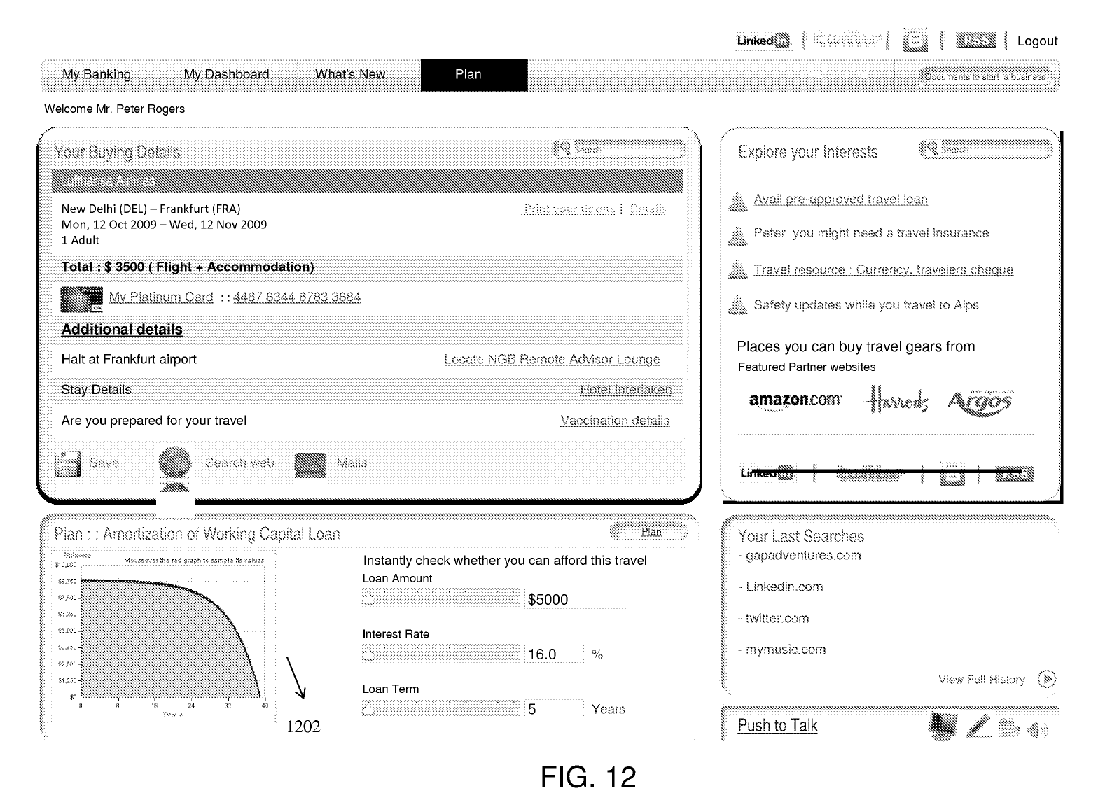

FIG. 11 illustrates a partner portal 1102 linked to e-banking page of the customer, whereas, FIG. 12 illustrates the provision of financial tools 1202 to the customer for planning his/her trip. The present invention may be implemented in numerous ways including as a apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

What is claimed is:

1. A system for providing segment based differentiated customer experience solution, the system comprising:
one or more service applications comprising code configured to provide one or more services;
an integrator module configured to integrate the one or more service applications in order to provide the differentiated customer experience solution, wherein the one or more service applications are integrated using enterprise application integration framework; and
a host integration framework configured to provide functionalities for issuing service requests and managing responses for communication between the one or more service applications and the integrator module.

2. The system of claim 1, wherein the one or more service applications comprises at least one of internet banking, mobile banking, remote advisement, customer experience solutions, financial applications and applications provided by partner portals.

3. The system of claim 1, wherein the integrator module comprises:
one or more Java APIs configured to enable implementation of the one or more service applications, wherein the one or more Java APIs comprise Enterprise Java Beans and Message Driven Beans;
a rule set layer configured to parse a request XML message and convert the message into a Java message object;
a websphere SOAP servlet configured to generate responses based on requests received from a web services enabled client;
an interface layer configured to transform the Java message object into an underlying host format and provide the formatted message to an adaptor layer; and
an adaptor layer configured to adapt and route the Java message object to a back-end host system, wherein the back-end host system comprises one or more software components configured to manage back-end processing for the implementation of one or more services applications.

4. The system of claim 3, wherein the interface layer is further configured to provide the Java message object to a database for future retrieval.

5. The system of claim 3, wherein exchange of messages between an asynchronous client and the integrator is executed using message oriented middleware for exchanging the messages.

6. The system of claim 3, wherein exchange of messages between a Java client and the integrator is executed using remote method invocation.

7. The system of claim 3, wherein exchange of messages between a web services enabled client and the integrator is executed using a web server.

8. The system of claim 3, wherein the back-end host system comprises:
an SSO system configured to facilitate single user sign-on for accessing multiple service applications;
a CRM system configured to manage customer relationships using software tools for interacting with customers;
a Core system configured to manage banking transactions related to the one or more service applications; and
an Alert Server configured to facilitate delivery of alerts linked with provision of the one or more service applications.

9. The system of claim 8, wherein the integrator is further configured to integrate the back-end host system with the one or more service applications using adaptors and translators.

10. The system of claim 1, wherein the host integration framework comprises:
an orchestrator configured to receive an incoming request and co-ordinate processing of the request;
a request processor comprising modules for splitting the request and executing sequencing, pagination and composition of a response message;
a message adaptor module configured to manage processing of individual messages, wherein the message adaptor module comprises a message routing module configured to route messages; and
a protocol handler module configured to provide protocol-specific logic pertaining to at least one of TCP/IP protocol, JMS protocol and JDBC protocol.

11. The system of claim 10, wherein the orchestrator comprises:
a transaction management module configured to enable composition and co-ordination of services into transactions and collaborative business processes; and
a state management module configured to ascertain current activity in progress for the request.

12. The system of claim 10 further comprising:
a lifecycle management module configured to manage processing of entire lifecycle of a transaction associated with a customer service application;
a message transformer configured to manage transformation of messages from a particular format to a system understandable format;
a tooling module configured to facilitate protocol mapping and transforming from an underlying technology perspective;
an infrastructure management module configured to map one or more infrastructure components downstream and upstream;
a persistence module configured to continuously monitor and bring quality control equivalent functionality between interaction of various modules and further checks for online/offline status of customer on a persistent basis; and
an administration and monitoring module adapted to configure and manage administrative activity related parameters for the entire lifecycle of a transaction.

13. A method for providing segment based differentiated customer experience solution, the method comprising:
receiving information about online status of a customer, wherein information about online status is received as a result of customer login and comprises transaction information, customer feedback and tacit information related to customer transactions;
providing one or more personalized offers based on the received information, wherein providing personalized offers comprises providing links related to personalized offers and displaying news related to the personalized offers;
invoking remote financial advisor for facilitating interaction between the customer and an advisor in an advisement session;
providing financial analysis related to the purchase of one or more personalized offers; and
provisioning the purchase of a personalized offer comprising completing transaction details for the purchase.

14. The method of claim 13, wherein the purchased personalized offer is a trip to a distant location, the method further comprising:
tracking physical location of the customer on the trip using a mobile GPS system;
generating personalized offers based on location of the customer, customer preference and current activity context; and
communicating the offers to the customer in the form of alerts, wherein the alerts are at least one of SMS alerts and email alerts.

15. The method of claim 13 further comprising facilitating the provision of real-time advice to the customer through a remote advisement session.
